(19) United States
(12) Patent Application Publication
(10) Pub. No.: US 2022/0142156 A1
(43) Pub. Date: May 12, 2022

(54) FRUIT BLOSSOM END ROT-PREVENTING AGENT COMPRISING NITROPHENOL COMPOUND OR SALT THEREOF

(71) Applicant: OAT Agrio Co., Ltd., Chiyoda-ku, Tokyo (JP)

(72) Inventors: Keijiro KITO, Naruto-shi, Tokushima (JP); Yoshinori YAMAMOTO, Ikoma-gun, Nara (JP)

(73) Assignee: OAT Agrio Co., Ltd., Chiyoda-ku, Tokyo (JP)

(21) Appl. No.: 17/593,615

(22) PCT Filed: Apr. 6, 2020
(86) PCT No.: PCT/JP2020/015572

§ 371 Date: Sep. 21, 2021

(30) Foreign Application Priority Data
Apr. 6, 2019 (JP) 2019-073213

(51) Int. Cl. A01N 33/22; A01G 7/06

(52) U.S. Cl. CPC A01N 33/22; A01G 7/06

(57) ABSTRACT

It is an object of the present invention to provide a novel inhibitor of blossom-end rot in a fruit. A nitrophenol compound or a salt thereof can inhibit blossom-end rot in a fruit. In particular, the present invention relates to an inhibitor of blossom-end rot in a fruit comprising a nitrophenol compound or a salt thereof, a method of inhibiting blossom-end rot in a fruit, comprising applying a nitrophenol compound or a salt thereof, a method of reducing the incidence of a blossom-end rot symptom in a fruit, improving a quality of the fruit, or increasing a yield of the fruit, the method comprising applying a nitrophenol compound or a salt thereof, and so on.

### CROSS REFERENCE TO RELATED APPLICATIONS

This application is a national stage application, filed under 35 U.S.C. § 371, of International Application No. PCT/JP2020/015572, filed Apr. 6, 2020, which claims priority to Japan Application No. 2019-073213, filed Apr. 6, 2019, the contents of both of which as are hereby incorporated by reference in their entirety.

### TECHNICAL FIELD

The present invention relates to an inhibitor of blossom-end rot in a fruit comprising a nitrophenol compound or a salt thereof.

### DESCRIPTION OF RELATED ART

Blossom-end rot in fruits of solanaceous plants is one of important physiological disorders in which the ends of the fruits are rotten, and many studies have been previously made thereon. In general, it is known that blossom-end rot is caused by an insufficient calcium concentration in a fruit. Thus, the prevention of blossom-end rot has been previously made by using calcium fertilizers, such as magnesium lime and water-soluble calcium.

The cause of the occurrence of blossom-end rot, however, has not been fully elucidated yet. Blossom-end rot can occur, for example, due to an excess or deficiency of soil nutrients, a water deficiency, the growth state of the plant, or the conditions of the surrounding environment.

Thus, there has been a problem in that blossom-end rot in tomatoes cannot be inhibited by simply applying calcium (lime) into soil.

Accordingly, Japanese Patent Application Publication No. 2010-280677 A, for example, discloses a composition for reducing or alleviating the incidence of blossom-end rot symptoms in tomatoes, increasing the yield, or improving the sugar content, the composition comprising a by-product of sugar manufacture produced in the production of beet sugar from sugar beet, the by-product comprising a saccharide, an organic acid, an amino acid, and betaine.

However, the by-product of sugar manufacture described in Japanese Patent Application Publication No. 2010-280677 A is a waste liquid collected from a sugar solution obtained after the collection of sugar from sugar beet, and further purified using chromatography, an ion exchange resin, or the like. Thus, this technique is regarded as having a very complicated refining process, and costly.

Accordingly, there is a need for the development of a blossom-end rot inhibitor that is obtained by a simple method, is inexpensive, and exhibits an excellent effect.

### SUMMARY OF INVENTION

It is an object of the present invention to provide a novel inhibitor of blossom-end rot in a fruit.

As a result of extensive research to solve the aforementioned problem, the present inventors have found that a nitrophenol compound or a salt thereof inhibits blossom-end rot in a fruit. The present invention has been completed based on this finding.

In summary, the present invention relates to a blossom-end rot inhibitor comprising a nitrophenol compound or a salt thereof; and so on, as given below:

Item 1.

An inhibitor of blossom-end rot in a fruit comprising a nitrophenol compound or a salt thereof.

Item 2.

The inhibitor of blossom-end rot in a fruit according to item 1, wherein the inhibitor reduces the incidence of a blossom-end rot symptom in the fruit, improves a quality of the fruit, or increases a yield of the fruit.

Item 3.

The inhibitor of blossom-end rot in a fruit according to item 1 or 2, wherein the nitrophenol compound is a compound having one or more nitro groups and one or more hydroxy groups.

Item 4.

The inhibitor of blossom-end rot in a fruit according to any one of items 1 to 3, wherein the nitrophenol compound or a salt thereof is a nitrophenol compound represented by general formula (1):

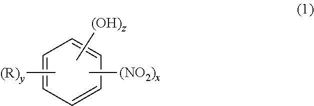

wherein R represents a hydrogen atom, a halogen atom, a C₁₋₆ alkyl group, a C₁₋₆ haloalkyl group, a C₁₋₆ alkoxy group, a C₁₋₆ haloalkoxy group, a C₂₋₆ alkenyl group, a C₂₋₆ haloalkenyl group, a C₂₋₆ alkenyloxy group, a C₂₋₆ haloalkenyloxy group, a C₂₋₆ alkynyl group, a C₂₋₆ haloalkynyl group, a C₂₋₆ alkynyloxy group, or a C₂₋₆ haloalkynyloxy group;

x represents an integer from 1 to 5; y represents an integer from 0 to 4; z represents an integer from 1 to 5; and

when y is an integer from 2 to 4, the two to four R groups may each be the same or different;

or a salt thereof.

Item 5.

The inhibitor of blossom-end rot in a fruit according to any one of items 1 to 4, wherein the nitrophenol compound or a salt thereof is a nitrophenol compound represented by general formula (2):

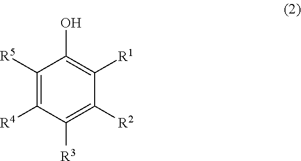

wherein R¹, R², R³, R⁴, and R⁵ groups are the same or different, and each represents a hydrogen atom, a halogen atom, a hydroxy group, a nitro group, a C₁₋₆ alkyl group, a C₁₋₆ haloalkyl group, a C₁₋₆ alkoxy group, a C₁₋₆ haloalkoxy group, a C₂₋₆ alkenyl group, a C₂₋₆ haloalkenyl group, a C₂₋₆ alkenyloxy group, a C₂₋₆ haloalkenyloxy group, a C₂₋₆ alkynyl group, a C₂₋₆ haloalkynyl group, a C₂₋₆ alkynyloxy group, or a C₂₋₆ haloalkynyloxy group,

wherein at least one of the R¹, R², R³, R⁴, and R⁵ groups represents a nitro group;

or a salt thereof.

Item 6.

The inhibitor of blossom-end rot in a fruit according to any one of items 1 to 5, wherein the fruit is a solanaceous plant.

Item 7.

The inhibitor of blossom-end rot in a fruit according to item 6, wherein the solanaceous plant is a tomato, an eggplant, or a green pepper.

Item 8.

The inhibitor of blossom-end rot in a fruit according to item 6 or 7, wherein the solanaceous plant is a tomato.

Item 9.

A method of inhibiting blossom-end rot in a fruit, comprising applying a nitrophenol compound or a salt thereof.

Item 10.

A method of inhibiting blossom-end rot in a fruit, comprising treating a plant or rhizosphere thereof with a nitrophenol compound or a salt thereof.

Item 11.

A method of reducing the incidence of a blossom-end rot symptom in a fruit, improving a quality of the fruit, or increasing a yield of the fruit, the method comprising applying a nitrophenol compound or a salt thereof.

Item 12.

A method of reducing the incidence of a blossom-end rot symptom in a fruit, improving a quality of the fruit, or increasing a yield of the fruit, the method comprising treating a plant or rhizosphere thereof with a nitrophenol compound or a salt thereof.

Item 13.

A method of use of a nitrophenol compound or a salt thereof, for inhibiting blossom-end rot in a fruit.

Item 14.

A method of use of a nitrophenol compound or a salt thereof, for reducing the incidence of a blossom-end rot symptom in a fruit, improving a quality of the fruit, or increasing a yield of the fruit.

Item 15.

A method of treating a plant or rhizosphere thereof with the inhibitor of blossom-end rot in a fruit according to any one of items 1 to 8.

In accordance with the present invention, a nitrophenol compound or a salt thereof can prevent blossom-end rot in a fruit.

### BRIEF DESCRIPTION OF DRAWINGS

FIG. 1 is a graph showing the accumulated number of occurrences (in number) of blossom-end rot fruits from the first to fifth clusters, with respect to treatment plots A to F (Examples 1 to 6) each using a blossom-end rot inhibitor of the present invention and a control plot (Comparative Example 1).

FIG. 2 is a graph showing the water-soluble calcium concentration in fruits for each of the harvested clusters (second and sixth clusters), with respect to treatment plots G and J (Examples 7 and 8) each using a blossom-end rot inhibitor of the present invention and a control plot (Comparative Example 2).

FIG. 3 is a graph showing the incidence of blossom-end rot fruits for each of the investigated clusters, with respect to a treatment plot H (Example 9) using a blossom-end rot inhibitor of the present invention and a control plot (Comparative Example 3).

FIG. 4 is a graph showing the incidence of blossom-end rot fruits for each of the investigated clusters, with respect to a treatment plot I (Example 10) using a blossom-end rot inhibitor of the present invention and a control plot (Comparative Example 4).

### DESCRIPTION OF EMBODIMENTS

1. Inhibitor of Blossom-End Rot in Fruit

An inhibitor of blossom-end rot in a fruit of the present invention (sometimes simply referred to as “blossom-end rot inhibitor” or “blossom-end rot inhibitor of the present invention”) comprises a nitrophenol compound or a salt thereof. The blossom-end rot inhibitor of the present invention may also be expressed as an agent for preventing blossom-end rot in a fruit of a solanaceous plant; an agent for reducing blossom-end rot in a fruit of a solanaceous plant; an agent for reducing the incidence of blossom-end rot in a fruit of a solanaceous plant; an agent for improving the quality of a fruit of a solanaceous plant; an agent for improving the yield of a fruit of a solanaceous plant; or an agent for increasing the yield of a fruit of a solanaceous plant.

Nitrophenol Compound or Salt Thereof

As used herein, the nitrophenol compound refers to an aromatic ring compound having one or more nitro groups and one or more hydroxy groups (OH groups). The nitrophenol compound includes a phenolic compound having one nitro group; and a phenolic compound having two or more nitro groups. These phenolic compounds further encompass those having one hydroxy group and those having two or more hydroxy groups. Thus, the nitrophenol compound as used herein includes all of the following: an aromatic ring compound having one nitro group and one hydroxy group; an aromatic ring compound having one nitro group and two or more hydroxy groups; an aromatic ring compound having two or more nitro groups and one hydroxy group; and an aromatic ring compound having two or more nitro groups and two or more hydroxy groups.

Examples of the aromatic ring constituting the nitrophenol compound include, but are not specifically limited to, a benzene ring, a naphthalene ring, and an anthracene ring.

The nitrophenol compound may further have a substituent other than the nitro groups and the hydroxy groups.

Examples of the substituent include, but are not specifically limited to, a halogen atom, a C₁₋₆ alkyl group, a C₁₋₆ haloalkyl group, a C₁₋₆ alkoxy group, a C₁₋₆ haloalkoxy group, a C₂₋₆ alkenyl group, a C₂₋₆ haloalkenyl group, a C₂₋₆ alkenyloxy group, a C₂₋₆ haloalkenyloxy group, a C₂₋₆ alkynyl group, a C₂₋₆ haloalkynyl group, a C₂₋₆ alkynyloxy group, and a C₂₋₆ haloalkynyloxy group.

The nitrophenol compound as used herein may form a salt. That is, the blossom-end rot inhibitor of the present invention may be not only the nitrophenol compound, but also a salt of the nitrophenol compound.

Examples of the salt as used herein include, but are not specifically limited to, alkali metal salts (such as sodium salt and potassium salt), alkaline earth metal salts (such as calcium salt and magnesium salt), and ammonium salts (such as ammonia; and organic amines, such as morpholine, piperidine, pyrrolidine, a lower mono-, di-, or tri-alkylamine, and a lower mono-, di-, or tri-hydroxyalkylamine). The salt of the nitrophenol compound is preferably an agrochemically acceptable salt, and more preferably an alkali metal salt.

Among the above-mentioned nitrophenol compounds, the phenolic compound having one nitro group is preferred. The aromatic ring constituting the nitrophenol compound is preferably a benzene ring.

Among the above-mentioned nitrophenol compounds, the nitrophenol compound in which the aromatic ring is a benzene ring may be, for example, a nitrophenol compound represented by general formula (1):

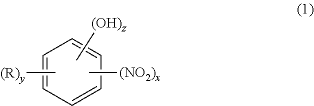

wherein R represents a hydrogen atom, a halogen atom, a hydroxy group, a nitro group, a C₁₋₆ alkyl group, a C₁₋₆ haloalkyl group, a C₁₋₆ alkoxy group, a C₁₋₆ haloalkoxy group, a C₂₋₆ alkenyl group, a C₂₋₆ haloalkenyl group, a C₂₋₆ alkenyloxy group, a C₂₋₆ haloalkenyloxy group, a C₂₋₆ alkynyl group, a C₂₋₆ haloalkynyl group, a C₂₋₆ alkynyloxy group, or a C₂₋₆ haloalkynyloxy group;

x represents an integer from 1 to 5; y represents an integer from 0 to 4; z represents an integer from 1 to 5; and

when y is an integer from 2 to 4, the two to four R groups may each be the same or different;

or a salt thereof.

The nitrophenol compound represented by general formula (1) includes a phenolic compound having one nitro group (x=1) (a mono-nitrophenol); and a phenolic compound having two or more nitro groups (x≥2) (a multi-nitrophenol). The phenolic compound having one nitro group (a mono-nitrophenol) further includes benzene having one nitro group and one hydroxy group (x=1 and z=1) (mono-nitrophenol); and benzene having one nitro group and two or more hydroxy groups (x=1 and z≥2) (mono-nitropolyphenol). The phenolic compound having two or more nitro groups (a multi-nitrophenol) further includes benzene having two or more nitro groups and one hydroxy group (x≥2 and z=1) (multi-nitrophenol); and benzene having two or more nitro groups and two or more hydroxy groups (x≥2 and z≥2) (multi-nitropolyphenol). Among the above, the phenolic compound having one nitro group is preferred.

The nitrophenol compound may also be, for example, a nitrophenol compound represented by general formula (2):

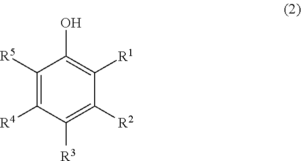

wherein R¹, R², R³, R⁴, and R⁵ groups are the same or different, and each represents a hydrogen atom, a halogen atom, a hydroxy group, a nitro group, a C₁₋₆ alkyl group, a C₁₋₆ haloalkyl group, a C₁₋₆ alkoxy group, a C₁₋₆ haloalkoxy group, a C₂₋₆ alkenyl group, a C₂₋₆ haloalkenyl group, a C₂₋₆ alkenyloxy group, a C₂₋₆ haloalkenyloxy group, a C₂₋₆ alkynyl group, a C₂₋₆ haloalkynyl group, a C₂₋₆ alkynyloxy group, or a C₂₋₆ haloalkynyloxy group,

wherein at least one of the R¹, R², R³, R⁴, and R⁵ groups represents a nitro group;

or a salt thereof.

The nitrophenol compound represented by general formula (2) includes phenol having one nitro group (wherein any one of the R¹, R², R³, R⁴, and R⁵ groups is a nitro group) (mono-nitrophenol); and phenol having two or more nitro groups (wherein two or more of the R¹, R², R³, R⁴, and R⁵ groups are nitro groups) (multi-nitrophenol).

Each of the groups as used herein will be described below.

Examples of the halogen atom include, but are not specifically limited to, a fluorine atom, a chlorine atom, a bromine atom, and an iodine atom.

Examples of the C₁₋₆ alkyl group include, but are not specifically limited to, linear or branched alkyl groups having 1 to 6 carbon atoms, such as methyl, ethyl, n-propyl, isopropyl, n-butyl, isobutyl, s-butyl, t-butyl, n-pentyl, isopentyl, neopentyl, n-hexyl, and isohexyl. As used herein, “n-” denotes normal, “s-” denotes secondary, and “t-” denotes tertiary.

Examples of the C₁₋₆ haloalkyl group include, but are not specifically limited to, linear or branched alkyl groups having 1 to 6 carbon atoms, which are substituted with 1 to 9, preferably 1 to 5, halogen atoms, such as fluoromethyl, chloromethyl, bromomethyl, iodomethyl, difluoromethyl, trifluoromethyl, 1-fluoroethyl, 2-fluoroethyl, 2-chloroethyl, 2,2,2-trifluoroethyl, pentafluoroethyl, 1-fluoropropyl, 2-chloropropyl, 3-fluoropropyl, 3-chloropropyl, 1-fluorobutyl, 1-chlorobutyl, and 4-fluorobutyl.

Examples of the C₁₋₆ alkoxy group include, but are not specifically limited to, linear or branched alkoxy groups having 1 to 6 carbon atoms, such as methoxy, ethoxy, n-propoxy, isopropoxy, n-butoxy, isobutoxy, s-butoxy, t-butoxy, n-pentyloxy, isopentyloxy, neopentyloxy, n-hexyloxy, and isohexyloxy.

Examples of the C₁₋₆ haloalkoxy group include, but are not specifically limited to, linear or branched alkoxy groups having 1 to 6 carbon atoms, which are substituted with 1 to 9, preferably 1 to 5, halogen atoms, such as fluoromethoxy, chloromethoxy, bromomethoxy, iodomethoxy, difluoromethoxy, trifluoromethoxy, 1-fluoroethoxy, 2-fluoroethoxy, 2-chloroethoxy, 2,2,2-trifluoroethoxy, pentafluoroethoxy, 1-fluoropropoxy, 2-chloropropoxy, 3-fluoropropoxy, 3-chloropropoxy, 1-fluorobutoxy, 1-chlorobutoxy, and 4-fluorobutoxy.

Examples of the C₂₋₆ alkenyl group include, but are not specifically limited to, linear or branched alkenyl groups having 2 to 6 carbon atoms, such as vinyl, 1-propenyl, allyl, isopropenyl, 1-butenyl, 2-butenyl, 3-butenyl, 1-methyl-2-propenyl, and 1,3-butadienyl.

Examples of the C₂₋₆ haloalkenyl group include, but are not specifically limited to, linear or branched alkenyl groups having 2 to 6 carbon atoms that have at least one double bond at any position, which are substituted with 1 to 13, preferably 1 to 7, halogen atoms, such as 2,2-dichlorovinyl, 2,2-dibromovinyl, 3-chloro-2-propenyl, 3,3-difluoro-2-allyl, 3,3-dichloro-2-allyl, 4-chloro-2-butenyl, 4,4,4-trifluoro-2-butenyl, 4,4,4-trichloro-3-butenyl, 5-chloro-3-pentenyl, and 6-fluoro-2-hexenyl.

Examples of the C₂₋₆ alkenyloxy group include, but are not specifically limited to, linear or branched alkenyloxy groups having 2 to 6 carbon atoms, such as vinyloxy, 1-propenyloxy, allyloxy, isopropenyloxy, 1-butenyloxy, 2-butenyloxy, 3-butenyloxy, 1-methyl-2-propenyloxy, and 1,3-butadienyloxy.

Examples of the C₂₋₆ haloalkenyloxy group include, but are not specifically limited to, linear or branched alkenyl groups having 2 to 6 carbon atoms that have at least one double bond at any position, which are substituted with 1 to 13, preferably 1 to 7, halogen atoms, such as 2,2-dichlorovinyloxy, 2,2-dibromovinyloxy, 3-chloro-2-propenyloxy, 3,3-difluoro-2-allyloxy, 3,3-dichloro-2-allyloxy, 4-chloro-2-butenyloxy, 4,4,4-trifluoro-2-butenyloxy, 4,4,4-trichloro-3-butenyloxy, 5-chloro-3-pentenyloxy, and 6-fluoro-2-hexenyloxy.

Examples of the C₂₋₆ alkynyl group include, but are not specifically limited to, linear or branched alkynyl groups having 2 to 6 carbon atoms, such as ethynyl, 1-propynyl, 2-propynyl, 1-methyl-2-propynyl, 1-butynyl, 2-butynyl, and 3-butynyl.

Examples of the C₂₋₆ haloalkynyl group include, but are not specifically limited to, linear or branched alkynyl groups having 2 to 6 carbon atoms that have at least one triple bond at any position, which are substituted with 1 to 13, preferably 1 to 7, halogen atoms, such as 3,3,3-trifluoropropynyl, 3,3-difluoropropynyl, 3,3,3-trifluorobutynyl, 4,4,4-trifluoro-2-butynyl, and 3,3-difluoro-butynyl.

Examples of the C₂₋₆ alkynyloxy group include, but are not specifically limited to, linear or branched alkynyloxy groups having 2 to 6 carbon atoms, such as ethynyloxy, 1-propynyloxy, 2-propynyloxy, 1-methyl-2-propynyloxy, 1-butynyloxy, 2-butynyloxy, and 3-butynyloxy.

Examples of the C₂₋₆ haloalkynyloxy group include, but are not specifically limited to, linear or branched alkynyloxy groups having 2 to 6 carbon atoms that have at least one triple bond at any position, which are substituted with 1 to 13, preferably 1 to 7, halogen atoms, such as 3,3,3-trifluoropropynyloxy, 3,3-difluoropropynyloxy, 3,3,3-trifluorobutynyloxy, 4,4,4-trifluoro-2-butynyloxy, and 3,3-difluoro-butynyloxy.

In the nitrophenol compound represented by general formula (1) or a salt thereof, R is preferably a hydrogen atom, a halogen atom, a C₁₋₆ alkyl group, or a C₁₋₆ alkoxy group, and more preferably a hydrogen atom or a methoxy group.

In the nitrophenol compound represented by general formula (2) or a salt thereof, R¹ is preferably a hydrogen atom, a halogen atom, a nitro group, a C₁₋₆ alkyl group, or a C₁₋₆ alkoxy group, and more preferably a hydrogen atom, a nitro group, or a methoxy group.

In the nitrophenol compound represented by general formula (2) or a salt thereof, R² is preferably a hydrogen atom, a halogen atom, a nitro group, a C₁₋₆ alkyl group, or a C₁₋₆ alkoxy group, and more preferably a hydrogen atom, a nitro group, or a methoxy group.

In the nitrophenol compound represented by general formula (2) or a salt thereof, R³ is preferably a hydrogen atom, a halogen atom, a nitro group, a C₁₋₆ alkyl group, or a C₁₋₆ alkoxy group, and more preferably a hydrogen atom, a nitro group, or a methoxy group.

In the nitrophenol compound represented by general formula (2) or a salt thereof, R⁴ is preferably a hydrogen atom, a halogen atom, a nitro group, a C₁₋₆ alkyl group, or a C₁₋₆ alkoxy group, and more preferably a hydrogen atom, a nitro group, or a methoxy group.

In the nitrophenol compound represented by general formula (2) or a salt thereof, R⁵ is preferably a hydrogen atom, a halogen atom, a nitro group, a C₁₋₆ alkyl group, or a C₁₋₆ alkoxy group, and more preferably a hydrogen atom, a nitro group, or a methoxy group.

Among the above-mentioned nitrophenol compounds or salts thereof, particularly preferred are nitrophenol compounds or salts thereof, such as 4-nitrophenol, 4-nitrophenol sodium salt, 3-nitrophenol, 3-nitrophenol sodium salt, 2-nitrophenol, and 2-nitrophenol sodium salt; and guaiacol compounds or salts thereof, such as 5-nitroguaiacol, 5-nitroguaiacol sodium salt, 4-nitroguaiacol, and 4-nitroguaiacol sodium salt.

Among the nitrophenol compounds represented by general formula (2) or salts thereof, preferred compounds are a nitrophenol compound wherein

R¹ represents a hydrogen atom, a nitro group, or a methoxy group,

R² represents a hydrogen atom, a nitro group, or a methoxy group,

R³ represents a nitro group,

R⁴ represents a hydrogen atom, a nitro group, or a methoxy group, and

R⁵ represents a hydrogen atom, a nitro group, or a methoxy group, or a salt thereof;

a nitrophenol compound wherein

R¹ represents a nitro group,

R² represents a hydrogen atom, a nitro group, or a methoxy group,

R³ represents a hydrogen atom, a nitro group, or a methoxy group,

R⁴ represents a hydrogen atom, a nitro group, or a methoxy group, and

R⁵ represents a hydrogen atom, a nitro group, or a methoxy group, or a salt thereof; and

a nitrophenol compound wherein

R¹ represents a hydrogen atom, a nitro group, or a methoxy group,

R² represents a hydrogen atom, a nitro group, or a methoxy group,

R³ represents a hydrogen atom, a nitro group, or a methoxy group,

R⁴ represents a nitro group, and

R⁵ represents a hydrogen atom, a nitro group, or a methoxy group, or a salt thereof.

Among the nitrophenol compounds represented by general formula (2) or salts thereof, more preferred compounds are a nitrophenol compound wherein

R¹ represents a hydrogen atom or a methoxy group,

R² represents a hydrogen atom or a methoxy group,

R³ represents a nitro group,

R⁴ represents a hydrogen atom or a methoxy group, and

R⁵ represents a hydrogen atom or a methoxy group, or a salt thereof; a nitrophenol compound wherein R¹ represents a nitro group,

R² represents a hydrogen atom or a methoxy group,

R³ represents a hydrogen atom or a methoxy group,

R⁴ represents a hydrogen atom or a methoxy group, and

R⁵ represents a hydrogen atom or a methoxy group, or a salt thereof; and

a nitrophenol compound wherein

R¹ represents a hydrogen atom or a methoxy group,

R² represents a hydrogen atom or a methoxy group,

R³ represents a hydrogen atom or a methoxy group,

R⁴ represents a nitro group, and

R⁵ represents a hydrogen atom or a methoxy group, or a salt thereof.

The blossom-end rot inhibitor of the present invention may contain one, or two or more nitrophenol compounds or salts thereof.

The one, or two or more nitrophenol compounds or salts thereof may each be a compound produced by a known method or a commercial product. Examples of known methods include the method described in JP 10-67716 A. The commercial product may be, for example, a nitrophenol composition containing two or three nitrophenol compounds or salts thereof, such as an aqueous solution containing 4-nitrophenol or a salt thereof (0.3%), 2-nitrophenol or a salt thereof (0.2%), and 5-nitroguaiacol or a salt thereof (0.1%).

In the treatment with the blossom-end rot inhibitor of the present invention, the concentration of the nitrophenol compound or a salt thereof is usually 0.00002 to 3000 mg/L, preferably 0.0002 to 300 mg/L, and more preferably 0.002 to 30 mg/L. Moreover, in the treatment with the blossom-end rot inhibitor of the present invention, when two or more nitrophenol compounds or salts thereof are contained, the concentration and the proportion of each of the compounds or salts can be appropriately adjusted.

Other Components

The blossom-end rot inhibitor of the present invention may contain only the nitrophenol compound or a salt thereof, without containing other components; usually, however, a solid carrier, a liquid carrier, or a gaseous carrier (propellant) may be mixed into the blossom-end rot inhibitor of the present invention.

Moreover, the blossom-end rot inhibitor of the present invention may optionally contain surfactants and other pharmaceutical adjuvants to be prepared into a formulation such as an oil, an emulsion, a wettable powder, a flowable agent, granules, a powder, an aerosol, or a fog, in accordance with a usual formulation method, and then used.

The formulation containing the blossom-end rot inhibitor of the present invention may or may not be mixed with other insecticides, nematicides, miticides, germicides, herbicides, microbial pesticides, plant growth regulators, synergists, soil conditioners, fertilizers, and the like, and may be used simultaneously therewith.

In this formulation, the content of the nitrophenol compound or a salt thereof is usually 0.00001 to 95% by weight, preferably 0.0001 to 50% by weight, and more preferably 0.001 to 10% by weight.

Examples of the solid carrier to be used in the preparation of the formulation include powders, granules, or the like of clays (such as kaolin clay, diatomaceous earth, synthetic hydrous silicon oxide, bentonite, fubasami clay, and acid clay), talcs, ceramics, other inorganic minerals (such as celite, quartz, sulfur, activated carbon, calcium carbonate, and hydrated silica), chemical fertilizers (such as ammonium sulfate, ammonium phosphate, ammonium nitrate, urea, and ammonium chloride), and the like.

Examples of the liquid carrier include water, alcohols (such as methanol and ethanol), ketones (such as acetone and methyl ethyl ketone), aromatic hydrocarbons (such as benzene, toluene, xylene, ethylbenzene, and methylnaphthalene), aliphatic hydrocarbons (such as hexane, cyclohexane, kerosene, and light oils), esters (such as ethyl acetate and butyl acetate), nitriles (such as acetonitrile and isobutyronitrile), ethers (such as diisopropyl ether and dioxane), acid amides (such as N,N-dimethylformamide and N,N-dimethylacetamide), halogenated hydrocarbons (such as dichloromethane, trichloroethane, and carbon tetrachloride), dimethyl sulfoxide, and vegetable oils, such as soybean oil and cotton seed oil.

Examples of the gaseous carrier include butane gas, LPG (liquefied petroleum gas), dimethyl ether, and carbon dioxide gas.

Examples of surfactants include alkyl sulfuric acid esters, alkyl sulfonic acid salts, alkyl aryl sulfonic acid salts, alkyl aryl ethers and polyoxyethylenated products thereof, polyethylene glycol ethers, polyhydric alcohol esters, and sugar alcohol derivatives.

Examples of pharmaceutical adjuvants include sticking agents, dispersants, and stabilizers.

Examples of sticking agents and/or dispersants include casein, gelatin, polysaccharides (such as starch powder, gum arabic, cellulose derivatives, and alginic acid), lignin derivatives, bentonite, saccharides, and synthetic water-soluble polymers (such as polyvinyl alcohol, polyvinyl pyrrolidone, and polyacrylic acids).

Examples of stabilizers include PAP (phosphoric acid isopropyl ester), BHT (2,6-di-tert-butyl-4-methylphenol), BHA (a mixture of 2-tert-butyl-4-methoxyphenol and 3-tert-butyl-4-methoxyphenol), vegetable oils, mineral oils, and fatty acids or esters thereof.

The blossom-end rot inhibitor of the present invention or the formulation containing the same may be used as is, or diluted with water or the like.

The amount and the concentration of the blossom-end rot inhibitor of the present invention or the formulation containing the same to be applied may both vary depending on the type of the formulation, the application period, the application place, the application method, the type of pest, and situations such as the degree of damage, and may be increased or decreased without being limited to the above-mentioned ranges.

The foregoing has described the case where the nitrophenol compound or a salt thereof is contained in the blossom-end rot inhibitor of the present invention and used; however, a composition separately containing the nitrophenol compound or a salt thereof and other components may be prepared in advance, and these two or more components may be used sequentially or simultaneously, preferably simultaneously, at the time of application. In this case, the nitrophenol compound or a salt thereof and the other components may be used together in the same proportions as mentioned above.

2. Use

The blossom-end rot inhibitor of the present invention also includes the meaning of an agent for preventing blossom-end rot in a fruit of a solanaceous plant; an agent for reducing blossom-end rot in a fruit of a solanaceous plant; an agent for reducing the incidence of blossom-end rot in a fruit of a solanaceous plant; an agent for improving the quality of a fruit of a solanaceous plant; an agent for improving the yield of a fruit of a solanaceous plant; or an agent for increasing the yield of a fruit of a solanaceous plant. The blossom-end rot inhibitor of the present invention can also be used as a plant growth regulator (sometimes also referred to as a plant growth adjuster).

Examples of usable plants for which the blossom-end rot inhibitor of the present invention can be used include, but are not specifically limited to, solanaceous plants, such as tomatoes, eggplants, and green peppers.

The blossom-end rot inhibitor of the present invention can protect the usable plants by treating the plants or the vicinity thereof.

The blossom-end rot inhibitor of the present invention can be applied to the vicinity, for example, stems, leaves, seeds, bulbs, or seed tubers (seeds, bulbs, or seed tubers will be hereinafter simply abbreviated as seeds); and fruits. Examples of application methods include application or spraying on leaves or stems, seed treatment (for example, seed soaking or seed dressing with granules), and application to soil (for example, furrow application or furrow spraying of granules).

3. Method

Another aspect of the present invention is a method of preventing blossom-end rot comprising applying a nitrophenol compound or a salt thereof. In particular, this aspect of the present invention is a method of reducing the incidence of a blossom-end rot symptom in a fruit, improving a quality of the fruit, or increasing a yield of the fruit, comprising applying the blossom-end rot inhibitor of the present invention. As used herein, applying includes treating a plant or rhizosphere thereof.

A still another aspect of the present invention is a method of use of a nitrophenol compound or a salt thereof, for inhibiting blossom-end rot in a fruit. In particular, this aspect of the present invention is a method of use of a nitrophenol compound or a salt thereof, for reducing the incidence of a blossom-end rot symptom in a fruit, improving a quality of the fruit, or increasing a yield of the fruit. The method of use may also be expressed as use.

A yet another aspect of the present invention is a method of treating a plant or rhizosphere thereof (treatment method) with the inhibitor of blossom-end rot in a fruit of the present invention.

As used herein, the rhizosphere of a plant means the soil or other peripheral regions that affect the roots. Examples of the rhizosphere include soil in a dry rice field, a flooded paddy field, a dry field, a tea field, an orchard, or the like; a seedling soil mix and a seedling mat in a seedling box or the like; and a hydroponic solution in a hydroponic farm.

Specific methods of direct application to roots or seeds include, for example, methods of spray treatment, smear treatment, soaking treatment, impregnation treatment, coating treatment, film coating treatment, and pellet coating treatment of roots or seeds with the inhibitor of blossom-end rot in a fruit of the present invention.

### EXAMPLES

The present invention will be specifically described hereinafter, with reference to examples and test examples, although the technical scope of the present invention is not limited to these examples.

### Formulation Example 1

Formulation A: Stock Solution of Aqueous Nitrophenol Solution

3.0 g of 4-nitrophenol sodium salt (manufactured by Asahi Chemical Manufacturing Co., Ltd.), 2.0 g of 2-nitrophenol sodium salt (manufactured by Asahi Chemical Manufacturing Co., Ltd.), and 1.0 g of 5-nitroguaiacol sodium salt (manufactured by Asahi Chemical Manufacturing Co., Ltd.) were dissolved in 1 L of ultrapure water to prepare a water-soluble agent. The water-soluble agent is hereinafter referred to as “formulation A”.

Formulation B: Nitrophenol Solution for Foliar Application

To 34.7 mL of the formulation A and 1 mL of Tween (registered trademark) 80 (manufactured by Tokyo Chemical Industry Co., Ltd.) as a spreading agent, tap water was added to give a volume of 10 L to prepare a water-soluble agent for foliar application. The water-soluble agent is hereinafter referred to as “formulation B”.

Formulation C: Nitrophenol Solution 1 for Irrigation Treatment

To 125 mL of the formulation A, tap water was added to give a volume of 10 L to prepare a stock solution of a water-soluble agent for irrigation treatment. The water-soluble agent is hereinafter referred to as “formulation C”.

Formulation D: Nitrophenol Solution 2 for Irrigation Treatment

To 75 mL of the formulation A, tap water was added to give a volume of 100 L to prepare a stock solution of a water-soluble agent for irrigation treatment. The water-soluble agent is hereinafter referred to as “formulation D”.

### Test Example 1

In the experiments, large tomatoes (cultivar: Taian-kichijitsu, manufacturer: Nanto Seed Co., Ltd.) were used as specimens. A 7.5-cm pot was filled with a seedling soil mix (Kumiai engei-you ikubyo baido, Aisai No. 1), and then seeds were planted on Jan. 17, 2017, and seedlings were raised for 6 weeks in an acrylic greenhouse; thereafter, the seedlings were planted in an elevated bed (width 30 cm, depth 20 cm, length 24 m) filled with a coconut husk soil mix in the acrylic greenhouse. The seedlings were planted in a single row at a spacing of 170 cm between ridges and a spacing of 30 cm between plants, with 78 plants planted for each ridge. Each ridge was divided into four plots, and then 16 plants in the center of each plot were used as test-plot plants, from which 10 medium-growth plants were selected and used as the plants to be investigated. The plants were trained to the left and right alternately. The plants were trained to a single main stem, appropriately defoliated, and not pinched. After the flowering period, Tomatotone (registered trademark, 4-CPA (p-chlorophenoxyacetic acid)) was applied at a 100-fold dilution to promote fruiting and fruit enlargement, and normal fruits were harvested as needed in the order of ripening. The harvest period was from May 12 to August 14. For fertilization and irrigation, a drip fertigation cultivation system (manufactured by OAT Agrio Co., Ltd.) was used. As a fertilizer formula, 10 kg of tank mix A (manufactured by OAT Agrio Co., Ltd.) was dissolved in about 150 L of water, 20 kg of tank mix B (manufactured by OAT Agrio Co., Ltd.) was added thereto, and then water was added to give a volume of 200 L to prepare a stock solution. The amount and the dilution factor of the solution were appropriately adjusted, and then the solution was applied. Separately, an agrochemical for pest control was applied each time, so as to maintain healthy growth of crops.

A control plot was set in which no treatment was performed. Subsequently, plots A and B were set in which a foliar application treatment using the formulation B was performed once weekly or biweekly, respectively. During the application, the treatment was performed using the formulation in an amount such that crops were uniformly smeared with the formulation. Additionally, a plot C was set in which an irrigation treatment was performed once biweekly, using the formulation C diluted 100-fold by the drip fertigation cultivation system, in an amount of 20 L per ridge; a plot D was set in which the formulation D was appropriately diluted, such that an amount of nitrophenol corresponding to that in the biweekly treatment was applied by irrigation, in combination with daily fertilization; plot E was set in which a foliar application treatment was performed biweekly using the formulation B, in addition to a biweekly irrigation treatment using the formulation C, and plot F was set in which a foliar application treatment was performed biweekly using the formulation B, in addition to a daily irrigation treatment using the formulation D. That is, a total of six plots were set, and then the treatments were performed. Specifically, the foliar application treatment was performed from March 30 to July 20, and the irrigation treatment was continuously performed from March 20 to July 19.

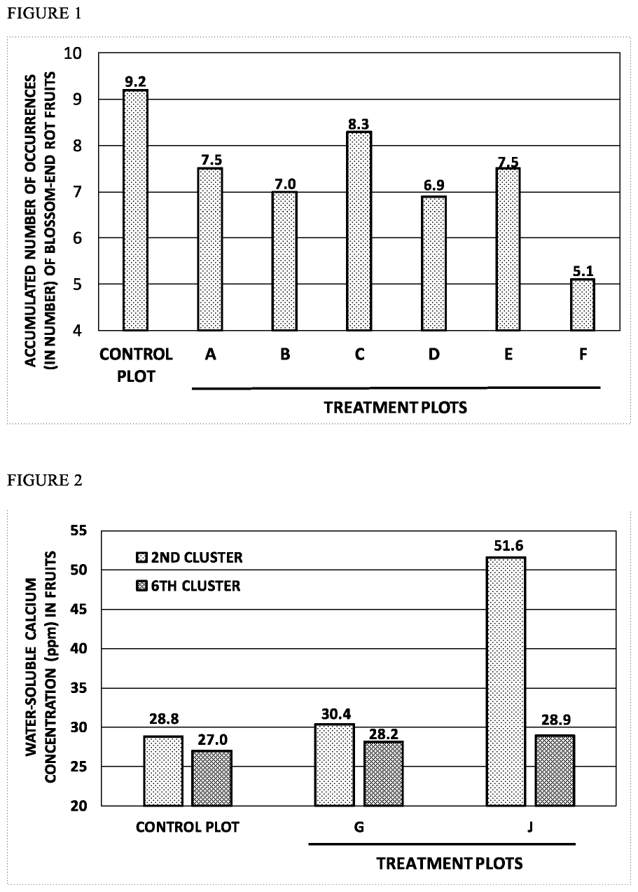

The numbers of occurrences of blossom-end rot fruits from the first to fifth clusters were investigated on May 12, and the total number of occurrences of blossom-end rot fruits was counted for each plant. The effect of the chemical treatment on the number of occurrences of blossom-end rot fruits was thus evaluated. After the investigation, the blossom-end rot fruits were thinned. Table 1 below shows a summary of the results of the investigation of the number of occurrences of blossom-end rot fruits and the p-value. FIG. 1 shows the results of the investigation of the number of occurrences of blossom-end rot fruits. As used herein, the p-value is a value obtained in t-test, which is a statistical analysis technique commonly used in agricultural studies. A smaller p-value can be interpreted to indicate a greater difference from the object of comparison. In general, a significance level of 0.05 or 0.01 is used.

TABLE 1

| | | Accumulated Number of | |
|---|---|---|---|
| | | Occurrences (in Number) of | |
| | Treatment | Blossom-End Rot Fruits | |
| | Plot | from the First to Fifth Clusters | p-value^{y} |
| Comparative | Control | 9.2 ± 0.49^{x} | — |
| Example 1 | Plot | | |
| Example 1 | Plo A | 7.5 ± 0.83 | 0.10 |
| Example 2 | Plot B | 7.0 ± 0.65 | 0.02 |
| Example 3 | Plot C | 8.3 ± 0.50 | 0.21 |
| Example 4 | Plot D | 6.9 ± 0.77 | 0.02 |
| Example 5 | Plot E | 7.5 ± 0.67 | 0.06 |
| Example 6 | Plot F | 5.1 ± 0.69 | 0.00 |

^{x}mean ± standard error
^{y}based on comparison with the control plot by t-test

<Results>

The results show that the number of occurrences of blossom-end rot fruits was reduced in all the treatment plots (plots A to F; Examples 1 to 6), compared with the control plot (Comparative Example 1). In particular, the plot B showed a statistical significance at a 5% significance level (p<0.05), and the plots D and F showed statistical significances at a 1% significance level (p<0.01). Thus, the treatment with the nitrophenol compound or a salt thereof is observed to have the effect of reducing the occurrences of blossom-end rot fruits.

### Formulation Example 2

Formulation E: Stock Solution of Aqueous Nitrophenol Solution 9.0 g of 4-nitrophenol sodium salt (manufactured by Asahi Chemical Manufacturing Co., Ltd.), 6.0 g of 2-nitrophenol sodium salt (manufactured by Asahi Chemical Manufacturing Co., Ltd.), and 3.0 g of 5-nitroguaiacol sodium salt (manufactured by Asahi Chemical Manufacturing Co., Ltd.) were dissolved in 1 L of ultrapure water to prepare a water-soluble agent. The water-soluble agent is hereinafter referred to as “formulation E”.

Formulation F: Nitrophenol Solution for Foliar Application

To 10 mL of the formulation E and 1 mL of Tween (registered trademark) 80 (manufactured by Tokyo Chemical Industry Co., Ltd.) as a spreading agent, tap water was added to give a volume of 10 L to prepare a water-soluble agent for foliar application. The water-soluble agent is hereinafter referred to as “formulation F”.

Formulation G: Nitrophenol Solution for Irrigation Treatment

To 40 mL of the formulation E, tap water was added to give a volume of 5 L to prepare a stock solution of a water-soluble agent for irrigation treatment. The water-soluble agent is hereinafter referred to as “formulation G”.

### Test Example 2

In the experiments, large tomatoes (cultivar: Taian-kichijitsu, manufacturer: Nanto Seed Co., Ltd.) were used as specimens. A 7.5-cm pot was filled with a seedling soil mix (Kumiai engei-you ikubyo baido, Aisai No. 1), and then seeds were planted on Feb. 2, 2018, and seedlings were raised for 6 weeks in an acrylic greenhouse; thereafter, the seedlings were planted in an elevated bed (width 30 cm, depth 20 cm, length 24 m) filled with a coconut husk soil mix in the acrylic greenhouse. The seedlings were planted in a single row at a spacing of 170 cm between ridges and a spacing of 30 cm between plants, with 78 plants planted for each ridge. Each ridge was divided into two plots, and then 36 plants in the center of each plot were used as test-plot plants. The plants were trained to the left and right alternately. The plants were trained to a single main stem, appropriately defoliated, and not pinched. After the flowering period, Tomatotone (registered trademark, 4-CPA (p-chlorophenoxyacetic acid)) was applied at a 100-fold dilution to promote fruiting and fruit enlargement, and normal fruits were harvested as needed in the order of ripening. The harvest period was from May 17 to July 12.

Formulation H: Fertilizer Stock Solution 1

5 kg of OAT House No. 1 (manufactured by OAT Agrio Co., Ltd.) was weighed out, and dissolved in tap water to give a volume of 100 L to prepare a fertilizer stock solution. The fertilizer solution is hereinafter denoted as “formulation H”.

Formulation I: Fertilizer Stock Solution 2

3.33 kg of OAT House No. 2 (manufactured by OAT Agrio Co., Ltd.) was weighed out, and dissolved in tap water to give a volume of 100 L to prepare a fertilizer stock solution. The fertilizer solution is hereinafter denoted as “formulation I”.

Formulation J: Fertilizer Stock Solution 3

7,500 g of OAT Aminomaster (registered trademark, manufactured by OAT Agrio Co., Ltd.) and 905 g of calcium chloride dihydrate (first grade, manufactured by Wako Pure Chemical Industries, Ltd.) were weighed out, and dissolved in tap water to give a volume of 80 L, to prepare a fertilizer stock solution. The fertilizer solution is hereinafter denoted as “formulation J”.

Formulation K: Fertilizer Stock Solution 4

10,000 g of NATURE AID (registered trademark, manufactured by Sakata Seed Corporation) and 905 g of calcium chloride dihydrate (first grade, manufactured by Wako Pure Chemical Industries, Ltd.) were dissolved in 80 L of water to prepare a fertilizer stock solution. The fertilizer solution is hereinafter denoted as “formulation K”.

[Fertilization Condition]

For fertilization and irrigation, a drip fertigation cultivation system (manufactured by OAT Agrio Co., Ltd.) was used, and the fertilization condition was changed for each ridge. As the fertilization condition, the ratio of dilution factors was fixed in accordance with the table below, and the following conditions were set: condition 1 in which nitrogen entirely derived from inorganic components is applied; condition 2 in which about 30% of the total nitrogen content is derived from OAT Aminomaster; and condition 3 in which about 30% of the total nitrogen content is derived from NATURE AID.

TABLE 2

| Fertilization | Formulation | Formulation | Formulation | Formulation |
|---|---|---|---|---|
| Condition | H | I | J | K |
| 1 | 100 | 100 | None | None |
| 2 | 100 | 340 | 145 | None |
| 3 | 100 | 340 | None | 145 |

For each of the fertilization conditions 1, 2, and 3, a control plot was set in which no treatment was performed. Subsequently, plots G (fertilization condition 1), H (fertilization condition 2), and I (fertilization condition 3) were set in which a foliar application treatment was performed once biweekly using the formulation F. During the application, the treatment was performed using the formulation in an amount such that crops were uniformly smeared with the formulation. Additionally, a plot J (fertilization condition 1) was set in which an irrigation treatment was performed once biweekly, using the formulation G diluted 100-fold by the drip fertigation cultivation system, in an amount of 16 L per ridge. Specifically, the foliar application treatment was performed from April 11 to June 13, and the irrigation treatment was continuously performed from March 20 to June 6.

<Fertilization Condition 1>

For the control plot of the fertilization condition 1, and the test plots G and J, the water-soluble calcium concentration in harvested fruits was analyzed. Of the normal fruits harvested from the second cluster on June 8 and the sixth cluster on July 2 in each test plot, 15 medium fruits were divided into five groups, i.e., three per group, and washed with ultrapure water. Thereafter, the calyx and the peduncle of the fruits were removed, and the vertical cross section of each fruit was cut into 1- to 2-mm-thick slices. A total of about 30 g of the slices were collected, the weight was measured, and then the slices were used as extracted samples. About 120 g of ultrapure water was added to the samples, the weight was measured, and then the samples were ground in Trio Blender. The ground samples were filtered using filter paper and a 0.2-cm membrane filter to obtain a solution for analysis. The analysis was performed using an ICP atomic emission spectrophotometer. Using the obtained analytical value, the water-soluble calcium concentration in the fruits was calculated in accordance with the following equation:

[concentration (g/g) in the fruits]=[analytical value (g/g)]×[total weighed value (g) of fruits and water]/[weighed value (g) of fruits] Equation 1:

Table 3 below shows a summary of the results of the analysis of the water-soluble calcium concentration in the normal fruits collected from each test plot. FIG. 2 shows the results of the analysis of the water-soluble calcium concentration in the normal fruits.

TABLE 3

| | | Harvested Cluster | | | | | |
|---|---|---|---|---|---|---|---|
| | | 2 | | | 6 | | |
| | | | | Ratio (%) | | | Ratio (%) |
| | Treatment | Concentration | p- | to Control | Concentration | p- | to Control |
| | Plot | (ppm) | value^{y} | Plot^{z} | (ppm) | value | Plot |
| Comparative | Control | 28.8 ± 3.49^{x} | — | — | 27.0 ± 1.37 | — | — |
| Example 2 | Plot | | | | | | |
| Example 7 | Plot G | 30.4 ± 2.36 | 0.72 | 105 | 28.2 ± 2.52 | 0.69 | 105 |
| Example 8 | Plot J | 51.6 ± 7.75 | 0.03 | 179 | 28.9 ± 1.38 | 0.35 | 107 |

^{x}mean ± standard error
^{y}based on comparison with the control plot by t-test
^{z}based on comparison between the mean of the control plot and the mean of the treatment plot

<Results>

The results confirmed a tendency of the water-soluble calcium concentration in the fruits to increase, which is correlated with the occurrence of blossom-end rot fruits, in both treatment plots (plots G and J; Examples 7 and 8) and both harvested clusters, compared with the control plot (Comparative Example 2). The results therefore support the effect of inhibiting blossom-end rot achieved by treating with the nitrophenol compound or a salt thereof.

As for the control plots of the fertilization conditions 2 and 3, and the test plots H and I, the number of occurrences of blossom-end rot fruits and the total number of produced fruits were counted for 20 plants in each plot, with respect to the first cluster on May 7, the second cluster on May 14, and the third and fourth clusters on May 30, and the cumulative incidence of blossom-end rot fruits in these clusters was calculated for each plant. The effect of the chemical treatment on the number of occurrences of blossom-end rot fruits was thus evaluated. After the investigation, the blossom-end rot fruits were thinned.

<Fertilization Condition 2>

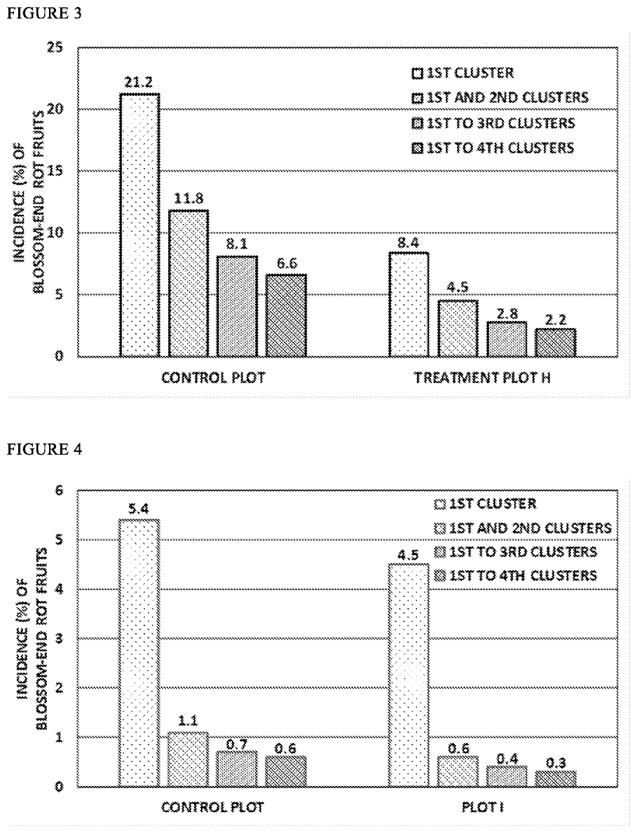

Table 4 below shows a summary of the results of the investigation of the incidence of blossom-end rot fruits under the fertilization condition 2. FIG. 3 shows the results of the investigation of the incidence of blossom-end rot fruits.

TABLE 4

| | Investigated Cluster | 1 | 1-2 | 1-3 | 1-4 |
|---|---|---|---|---|---|
| | Treatment Plot | Incidence of Blossom-End Rot Fruits | | | |
| Comparative Example 3 | Control Plot | 21.2 ± 5.56^{x} | 11.8 ± 3.18 | 8.1 ± 2.13 | 6.6 ± 1.79 |
| Example 9 | Plot H | 8.4 ± 3.12 | 4.5 ± 1.69 | 2.8 ± 1.02 | 2.2 ± 0.80 |
| | p-value | 0.05^{y} | 0.05 | 0.03 | 0.03 |

^{x}mean ± standard error
^{y}based on comparison with the control plot by t-test

<Fertilization Condition 3>

Table e below shows a summary of the results of the investigation of the incidence of blossom-end rot fruits under the fertilization condition 3. FIG. 4 shows the results of the investigation of the incidence of blossom-end rot fruits.

TABLE 5

| | Investigated Cluster | 1 | 1-2 | 1-3 | 1-4 |
|---|---|---|---|---|---|
| | Treatment Plot | Incidence of Blossom-End Rot Fruits | | | |
| Comparative Example 4 | Control Plot | 5.4 ± 1.20^{x} | 1.1 ± 0.75 | 0.7 ± 0.52 | 0.6 ± 0.44 |
| Example 10 | Plot I | 4.5 ± 1.00 | 0.6 ± 0.56 | 0.4 ± 0.38 | 0.3 ± 0.28 |
| | p-value | 0.65^{y} | 0.58 | 0.59 | 0.52 |

^{x}mean ± standard error
^{y}based on comparison with the control plot by t-test

<Results>

The results confirmed a tendency of the number of occurrences of blossom-end rot fruits to decrease, in both fertilization conditions and both treatment plots (plots H and I; Examples 9 and 10), compared with the control plots (Comparative Examples 3 and 4). In particular, the condition 2 showed statistical significances at a 5% significance level (p<0.05). Thus, the present treatment with the nitrophenol compound or a salt thereof is observed to be effective in reducing the occurrences of blossom-end rot fruits.

1. An inhibitor of blossom-end rot in a fruit comprising a nitrophenol compound or a salt thereof.

2. The inhibitor of blossom-end rot in a fruit according to claim 1, wherein the inhibitor reduces the incidence of a blossom-end rot symptom in the fruit, improves a quality of the fruit, or increases a yield of the fruit.

3. A method of inhibiting blossom-end rot in a fruit, comprising applying a nitrophenol compound or a salt thereof.

4. (canceled)

5. A method of use of a nitrophenol compound or a salt thereof, for inhibiting blossom-end rot in a fruit.

6. (canceled)

7. A method of treating a plant or rhizosphere thereof with the inhibitor of blossom-end rot in a fruit according to claim 1.
